(19) United States
(12) Patent Application Publication
(10) Pub. No.: US 2005/0052623 A1
(43) Pub. Date: Mar. 10, 2005

(54) Projecting system

(76) Inventor: Chao-Wang Hsiung, Chung Ho City (TW)

Correspondence Address: NATH & ASSOCIATES, 1030 15th STREET, NW, 6TH FLOOR, WASHINGTON, DC, 20005, US

(21) Appl. No.: 10/849,484

(22) Filed: May 20, 2004

(30) Foreign Application Priority Data
May 23, 2003 (TW) 92114070

(51) Int. Cl. G03B 21/26

(52) U.S. Cl. 353/94

(57) ABSTRACT

A projecting system utilizing a number of projectors to generate an output image includes a plurality of client electronic devices and a server electronic device, which are interconnected via a network. Each client electronic device contains a same divided media file and different environment parameters, and drives a corresponding projector by providing processed image data. The image data are processed by a curved surface calculation. These client electronic devices are synchronized with the server electronic device so that these client electronic devices cooperate to drive corresponding projectors for showing the output image.

### BACKGROUND OF THE INVENTION

1. Field of Invention

The invention relates to a projecting system and, in particular, to a projecting system utilizing a plurality of general-purpose projectors to produce a common image.

2. Related Art

With rapid progresses in electronic and information technologies, electronic devices and computers evolve from simple text interfaces to multimedia interfaces today, rendering more versatile applications in human life.

Generally speaking, multimedia files include both static and dynamic images, music, voices, and various sound effects. The visual presentation, in particular, plays an important role. For example, movies, interactive games, and applications of virtual reality all make a lot use of dynamic images.

Currently, tools for visual presentations include the combinations of playing circuits and the cathode ray tube (CRT), liquid crystal display (LCD), or plasma television screen. However, these screens are often limited by their sizes. Once they reach a certain size, the cost increases quickly.

The digital projector is designed to solve this problem. A common digital projector has an interface functioning as the signal input/output (IO) interface of the CRT or LCD screen. The digital projector uses this interface to receive image data from an electronic device such as the computer. The image data are converted by the photoelectric signal conversion circuit inside the digital projector into optical signals, which are then projected out through the lens.

As the digital projector uses the optical amplification principle, the image size is mainly determined by the distance from the digital projector to the screen. Generally speaking, as long as the output power of the digital projector is high enough, the projecting screen can be of any large size.

However, since the digital projector is designed such that the playing circuit and the screen are separate, the image effect is closely related to the screen configuration. In other words, the screen is often distorted when the shape/size of the screen or the distance between the screen and the projector is not in accord with the original design.

With higher quality demands, the projector applications will be greatly limited if the image distortion problem cannot be solved. For example, one often has to quickly set up the digital projector and the screen in an exhibition. The distance between the screen and the projector and the size of the screen are thus restricted by the allowed space. Therefore, how to provide a mechanism that enables one to quickly adjust the digital projector is an important issue.

Moreover, the commonly used digital projector is often designed for conventional screens, such as the CFT or LCD screens. The main purpose is to magnify the image originally projected onto a conventional screen. For special screens, such as a surrounding screen or a wavy screen, a specially designed projector is needed. Another method is to redesign the conventional projector by including an additional optical lens set to fine-tune the projecting image. However, these methods are expensive and non-flexible, thus greatly restricting the applications of the digital projectors.

Since the digital projector can easily project out an image of the size of a room, it is particularly suitable for the virtual reality systems for the purposes of teaching, entertainments, and simulations. Again, we have to solve the above-mentioned problems before such applications can be widely accepted.

### SUMMARY OF THE INVENTION

An objective of the invention is to provide a projecting system with flexibility and scalability that can be quickly set up. Another objective of the invention is to provide a playing system that uses a number of projectors to produce an image. A further objective of the invention is to provide a playing program for several projectors to produce a common image. Yet another objective of the invention is to provide a storage medium for storing the playing program. A flirter objective of the invention is to provide a method of using several projectors to produce an image. Another further objective of the invention is to provide a three-dimensional virtual reality system.

According to a first embodiment of the invention, the playing system contains a screen, a plurality of projectors, a plurality of client electronic devices, a server electronic device, and a network. These client electronic devices and the server electronic device are interconnected by the wired or wireless network. Each client electronic device controls an associated projector responsible for a corresponding area on the screen.

These client electronic devices are stored with a media file and environment parameters. The environment parameters include the coordinates of the area on the image screen covered by the client electronic device. Each client electronic device generates an output image according to the environment parameters and the media file. The images can be adjusted according to the corresponding environment parameters first, such as a curved surface calculation, boundary-smoothing processing, and three-dimensional image rendering.

The client electronic devices are synchronized with the server electronic device via the network so that the client electronic devices cooperate to drive the corresponding projectors for showing output images in different areas on the screen, forming a complete output image.

The server electronic device can include an operating interface (OI) for the user to set the environment parameters of these client electronic devices. The OI may also enable the user to configure the whole system, e.g. installing media files into the client electronic devices or letting the user enter interactive commands to manipulate media files for different interactive presentations.

In practice, we can use an ordinary computer with utilities to form the system of client electronic devices and server electronic device. In other words, another embodiment of the invention includes a playing program to process the media files in accord to the environment parameters of the machines, thereby driving the projectors to show an output image.

We may also employ a multitasking device, using a more powerful computer to complete jobs of the multiple electronic devices. In practice, the computer outputs image signals for the projectors and the image signals are distributed by the multitasking device to the corresponding projectors.

Therefore, the invention provides a flexible playing structure with several projectors. The invention has many advantages. For example, the system has more flexibility and scalability. The numbers of client computers and projectors can be increased according to the screen size and the media file. Moreover, the disclosed system can be comprised of low-cost standardized computers and projectors. The maintenance and set up of such a system are much easier. Since the invention does not require any specially designed projector or complicated optical adjustment circuit, the output results can be dynamically tuned. This solves the adjustment problem when the screen and the processing circuit are separate. Furthermore, the invention forms the base of a virtual reality system to increase the extra value of the whole system.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a schematic view the first embodiment according to the invention;

FIG. 2(a) is a schematic view of an image without curve-surface processing;

FIG. 2(a) is a schematic view of a curve-surface processed image;

FIG. 3(a) is a schematic view of an image consisted of several screen areas;

FIG. 3(b) is a schematic view of two images with an overlapping region;

FIG. 4 is a schematic view of the hardware structure in the invention;

FIG. 5 is a schematic view of the software structure in the invention;

FIG. 6 is a flowchart of the disclosed method;

FIG. 7 is a schematic view of another embodiment;

FIG. 8(a) is a side view of an example according to the invention;

FIG. 8(b) is a top view of FIG. 8(a);

FIG. 8(c) shows several different applications; and

FIG. 8(d) is a three-dimensional view of the virtual reality system.

### DETAILED DESCRIPTION OF THE PREFERRED EMBODIMENT

### First Embodiment (Surrounding Screen Playing System)

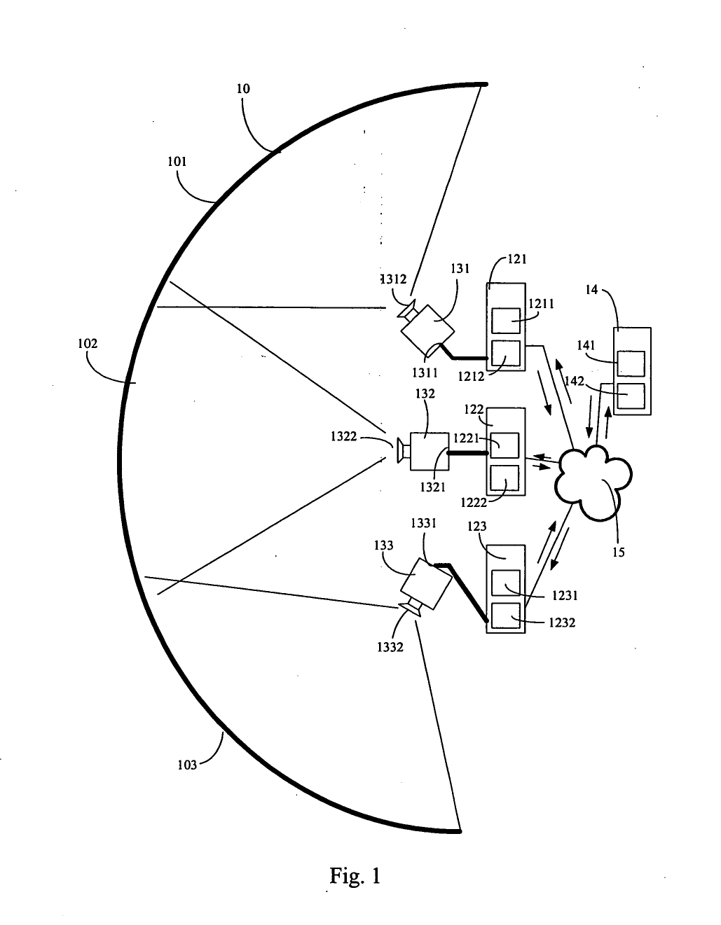

As shown in FIG. 1, the first embodiment of the projecting system contains a screen 10, a network 15, a number of projectors 131, 132, 133, a number of client electronic devices 121, 122, 123, and a server electronic device 14.

The screen 10 is defined in terms of several areas 101, 102, 103, corresponding to the projectors 131, 132, 133, respectively. The projectors 131, 132, 133 may be general-purpose digital projectors. They correspond to the client electronic devices 121, 122, 123, respectively. The projectors 131, 132, 133 have their own input terminals 1311, 1321, 1331 and projecting lenses 1312, 1322, 1332. The input terminals 1311, 1321, 1331 connect to the corresponding client electronic devices 121, 122, 123. The client electronic devices 121, 122, 123 provide the projectors 131, 132, 133 the image signals via the input terminals 1311, 1321, 1331. The projectors 131, 132, 133 convert the image signals into the corresponding optical images, which are then projected onto the corresponding areas 101, 102, 103 on the 10.

The client electronic devices 121, 122, 123 and the server electronic device 14 are interconnected via the network 15. The network 15 can be implemented using a TCP/IP Ethernet, or a wire or wireless IPX, 802.11a/b network that can exchange messages.

Each of the client electronic devices 121, 122, 123 has a first processor 1211, 1221, 1231 and a storage medium 1212, 1222, 1232. Each storage medium 1212, 1222, 1232 stores a media file, a first program, and environment parameters. Each first processor 1211, 1221, 1231 is used to the first program, converting the media file according to the environment parameters into the above-mentioned image signals. The projectors 131, 132, 133 are driven to project optical images.

The environment parameters include coordinate information, such as the screen area each client electronic device 121, 122, 123 is responsible for. For example, the first storage medium of each client electronic device 121, 122, 123 is stored with the same media file. Since the client electronic devices 121, 122, 123 control different areas 101, 102, 103 of the screen 10, the coordinate information in the environment parameters of the client electronic devices 121, 122, 123 indicates the initial and final positions of the image a client electronic device controls. When each of the client electronic devices 121, 122, 123 executes the first program, the corresponding projector 131, 132, 133 is driven according to the coordinate information to produce an optical image projected on the corresponding area 101, 102, 103 on the screen 10. They cooperate to generate a complete image.

The media file mentioned herein includes videos, animations, static pictures, and output images produced by a utility. In order for the projectors 131, 132, 133 to cooperate to finish an image at the same time, the client electronic devices 121, 122, 123 are synchronized with the server electronic device 14 via the network 10.

In the current embodiment, when the client electronic devices 121, 122, 123 finish the calculations of image signals based upon the media file according to the environment parameters, the network 15 sends a first synchronized signal to the server electronic device 14.

The server electronic device 14 has a second processor 141 and a second storage medium 142, which stores a second program for the second processor 141 to execute. When the second processor 141 of the server electronic device 14 executes the second program, it receives the first synchronized signals from the client electronic devices 121, 122, 123. After the server electronic device 14 executes the second program to collect all the first synchronized signals from the client electronic devices 121, 122, 123, it sends out a second synchronized signal to the client electronic devices 121, 122, 123.

After the client electronic devices 121, 122, 123 receive the second synchronized signal, it is transmitted to the output terminal of the corresponding projectors 131, 132, 133. Each of the projectors 131, 132, 133 outputs an optical image according to the image signal, forming a common image on the screen 10. Since this process is synchronized, the images in different areas 101, 102, 103 are virtually formed simultaneously, ensuring the synchronization of the images This is particularly important for animations or videos with multiple frames. Moreover, the effects will be more obvious when different areas of the whole image require different types of operations.

It should be pointed out that the client electronic devices 121, 122, 123 and the server electronic device 14 can be general-purpose computers, workstations, mini-hosts, laptop computers, tablet PC's, portable personal digital assistants (PDA), electronic devices with the 8051 chip, and special systems formed using digital signal processors.

Among these choices, a low-cost embodiment is using general-purpose computers installed with an ordinary operating system (OS) as the client electronic devices 121, 122, 123 and the server electronic device 14. The hard drives are installed with an appropriate utility. The general-purpose computers of the client electronic devices 121, 122, 123 perform operations on the media file (e.g. an animation file) stored in the hard drive, optical drive, or other storage media according to the environment parameters. The utility can be a media playing program written in the C/C++, Visual C++, C++ Builder, PASCAL, JAVA, Visual Basic, Assembly, or Pearl programming language. The environment parameters can be stored in a system parameter file, such as the registry in the Microsoft Windows OS.

In this embodiment, the screen 10 is a 180-degree surrounding screen. When using ordinary digital projectors 131, 132, 133 to project images on different areas 101, 102, 103, the images will be curved because they are originally designed to be projected on a planar screen. In order words, an originally straight line will be curved when projected onto the areas 101, 102, 103 of the surrounding screen

The curving phenomenon is already disturbing for a single projector. In the current embodiment, the images need to be properly connected. If the image distortion problem can be solved, the quality of the whole image will be greatly improved.

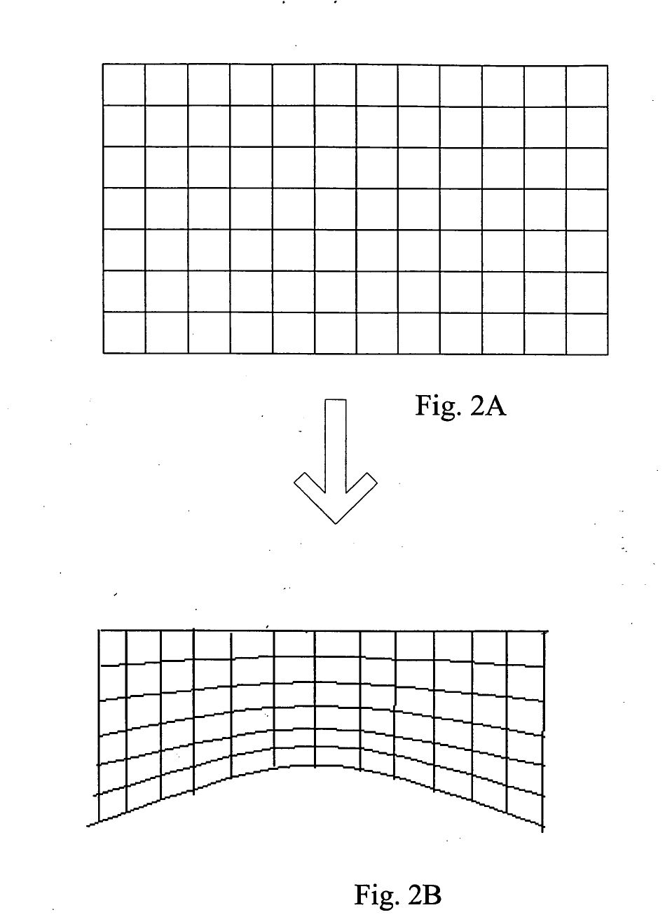

To solve this problem, we can include curve surface parameters in the environment parameters. When the client electronic devices 121, 122, 123 generate image signals, they do not only refer to the corresponding coordinates, but also make a curved surface correction according to the curve surface parameters. For example, the curve surface parameters can be the parameters of the Betz curve. By adjusting the curve surface parameters, the image signals are corrected before their output. For example, the image of FIG. 2(a) is first converted into that in FIG. 2(b). The image signals of FIG. 2(b) projected onto the curved surrounding screen can be corrected to obtain a non-curved image. When the curvature of the screen changes, one only needs to adjust the curve surface parameters.

Suppose the media file is a movie file. The client electronic devices 121, 122, 123 read the movie file and process one or several images at each synchronized time (e.g. between two second synchronized signals). Each client electronic device 121, 122, 123 controls one portion of the movie image extracted by the first program. The first program further supports a command or a routine to perform curve-surface processing before outputting the image data to the projectors 131, 132, 133. This method includes the step of reading the curve surface parameters in the environment parameters, e.g. the Betz curve parameters. Afterwards, the pixels of the image are converted to new coordinate axes using matrices to generate an image satisfying the Beta curve parameters. Finally, the processed images are output to the projectors 101, 102, 103.

In this embodiment, since each client electronic device is stored with the same media file, the information such as which client electronic device controls which area and how many client electronic devices constitute the projecting system is saved in the environment parameters. For example, if an image has 4096×768 pixels, we can use four client electronic devices (such as PC's with the same hardware structure) installed with the same utility and divided media files. The PC's are different in their environment parameters, including both the curve surface parameters and the coordinate information. The coordinate information of the four client PC's can be set to control the areas with the X coordinate 0˜1023, 1024˜2047, 2048˜3071, and 3072˜4096. For the same media file, we can also use two, eight, or any other number of client PC's to drive the corresponding projectors. The only setting one needs to take care of is the environment parameters. We thus see that the disclosed projecting system has high flexibility and scalability.

Another extension based on the above embodiment is to include boundary-smoothing information in the environment parameters. In the previous embodiment, the image projected on the screen is achieved using several projectors. In order to avoid discontinuities in the output image, one method is to overlap adjacent component images.

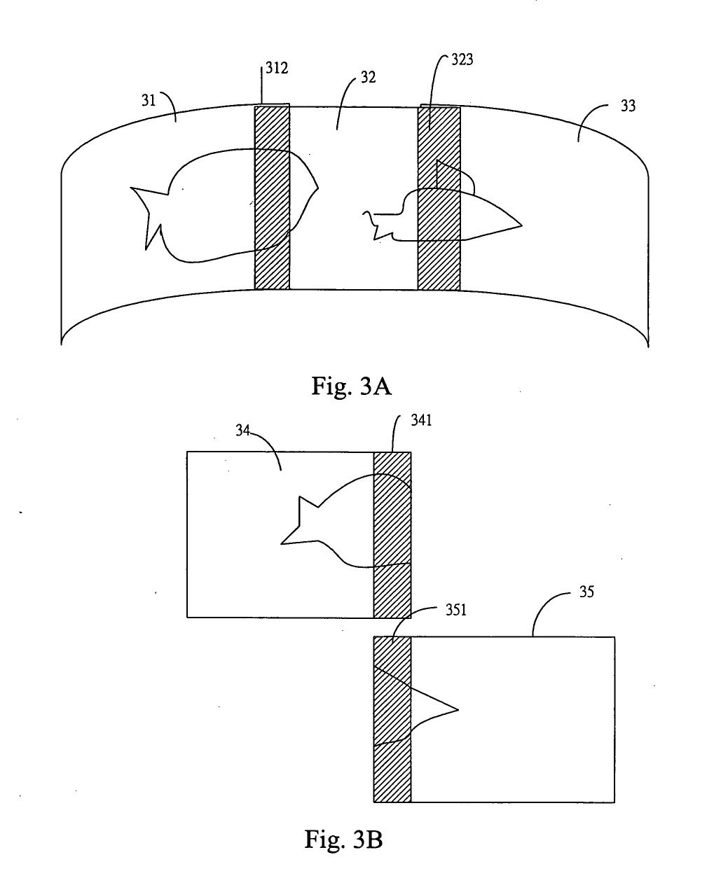

In FIG. 3(a), we show an example where part of the boundaries has an overlap. The screen areas 31, 32, 33 are processed by the above-mentioned three client electronic devices. The coordinate information in the environment parameters of the three client electronic devices includes an overlapping region with a certain width, such as the boundaries 312, 323.

The image at the boundary 312 or 323 is produced by two projectors in the same regions. In principle, the images from the two projectors in this region should be exactly the same and overlap on top of each other. However, they involve two different projectors projecting from different locations. In order for the boundary regions not to be fuzzy because the images from the two different projectors do not overlap properly, one can include the boundary-smoothing information. Before the first program generates the image signals to be sent to the projectors, the boundary parts are first processed according to the boundary-smoothing information.

As an example, in FIG. 3(b) the right-hand side of the screen area 34 has a boundary region 341 that needs to be smoothed and the left-hand side of the screen area 35 has a boundary region. 351 that also needs to be smoothed. The boundary-smoothing information can include the simplest boundary coordinates. For example, if a client electronic device processes an image with 1024×768 pixels and only its right-hand side has a boundary region that has an overlap with the image from another projector, then the X coordinate of the boundary region that needs to be smoothed is between 1000 and 1024. If the client electronic device has an image in which both sides have an overlap with images from other projectors, the boundary-smoothing information can be set to be 0˜24 and 1000˜1024. The first program uses this boundary-smoothing information to bend or distort the image in those boundary regions.

If the media file is an object file, then one can make only one projector to output the object in a specific boundary according to the boundary-smoothing information whereas the other projector does not output. This method can also avoid image blurring at the boundary.

The above embodiment can be extended in another way; namely, the server electronic device 14 is installed with an interface for the user to set various information or to interact with the system.

For example, the server electronic device 14 provides a screen, a keyboard, a mouse, a joystick, and an interface program to provide an OI. The user can use such input devices as the keyboard, mouse, and joystick to set the environment parameters of the client electronic devices 121, 122, 123.

A preferred method is to use the server electronic device 14 to provide the setting and calibration of the whole system. For example, the user directly adjusts the environment parameters of several client electronic devices from the OI of the server electronic device 14. The client electronic devices immediately show the result of the adjustment in the environment parameters.

This type of design and adjustment provides a very convenient and efficient method for the setting of the environment parameters such as the curve surface parameters or boundary-smoothing information. The user can use the same OI to adjust the environment parameter values of the client electronic devices individually or altogether. The environment parameters can also be set via a graphic interface of the OI. At the same time, the user can visually determine whether the adjusted curve surface parameters or boundary-smoothing information is suitable for the screen,

Consequently, the invention can quickly and dynamically adjust the playing system to a satisfactory playing state, no matter where it is, what the media file is, how many the projectors and corresponding computer devices are.

Since the standard personal computer (PC) is cheap but very powerful, each projector can be associated with a client PC in practice. The cost of the system will still be low even when the extra server PC is included. However, people skilled in the art should know that the scope of the invention also includes the case in which only one PC is used to drive multiple projectors and the case in which the server electronic device and one client electronic device are implemented on a same machine. This is made possible because the modern computer often provides the multitasking function and calculating power. From another point of view, the client electronic devices and the server electronic device can be implemented on several machines according to the needs. If a media file of 3D space requires a large amount of image operations, one can use several machines at the same time, such as a distributive system or a computer cluster.

Moreover, although we take a 180-degree screen as an example here, any skilled person can generalize it to 360-degree surrounding screens, to divide an image in the vertical direction, or to replace a television wall.

### Second Embodiment (3D Spatial Simulation System)

The invention uses several general-purpose digital projectors to provide an image based on a flexible structure. Therefore, the image can be projected on a surrounding screen with a long, wave, spherical, or even irregular shape.

To provide a powerful virtual reality system using the above-mentioned structure, we only need to make another OI. For example, we first prepare a 3D space model and store it in the media file. Afterwards, we take the environment parameters of the client electronic devices as the coordinates of the 3D space, observation coordinates, and the amplification ratio and adjust the curve surface parameters and the boundary-smoothing information according to the individual output screens. Moreover, we install an OI for the client electronic devices 14. Using the mouse, joystick, and gloves with motion sensors, the user can enter interactive commands of the 3D space.

For illustration purposes, we provide an embodiment of using general-purpose digital projectors to produce a 3D image. First, we use two projectors for a single screen area. The two projectors correspond to two client electronic devices. The two client electronic devices basically process the image of the same coordinates in the media file. The environment parameters further include a 3D visual parameter. One of the client electronic devices processes the image for the left eye, while the other client electronic device processes the image for the right eye. The two images are almost the same, except for some tiny difference which is used to enable people to perceive the image as a 3D image using both eyes. We provide different frequencies for the two images. Filtered by the lenses, the left eye can only perceive the image for the left eye whereas the right eye can only perceive the image for the right eye. Of course, people need to wear a pair of special 3D glasses to view the 3D image.

Since the 3D visual parameter is stored in the environment parameters, it can be used to determine the depth of a 3D image. Of course, we can also use the OI in the server electronic device 14 to adjust this parameter. During the process of adjusting the 3D visual parameter, the image can be played simultaneously to make the parameter adjustment intuitive.

Using the 3D effect and the good human-machine OI, these virtual reality systems can be widely used in the teaching of medicine (e.g. human anatomy), flight or vehicle simulations, solar systems, geography, chemistry, etc.

### Third Embodiment (Software System/Storage Media)

It should be pointed out that the invention can combine many general-purpose computers, digital projectors, and network devices (such as the network lines and routers or line collectors). Therefore, another viewpoint of the invention is to make a software system, which is installed by the user on several computers. These computers are interconnected and connected to the digital projectors, forming a projecting system.

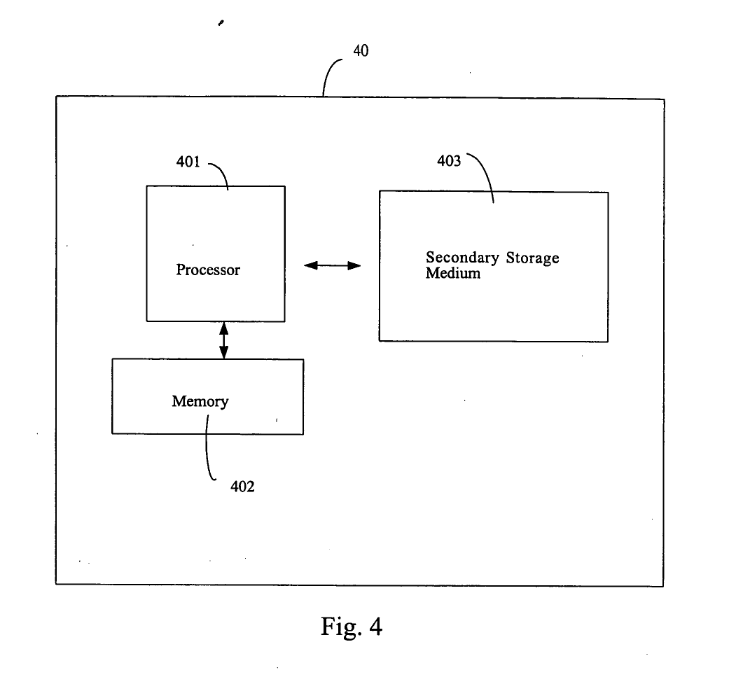

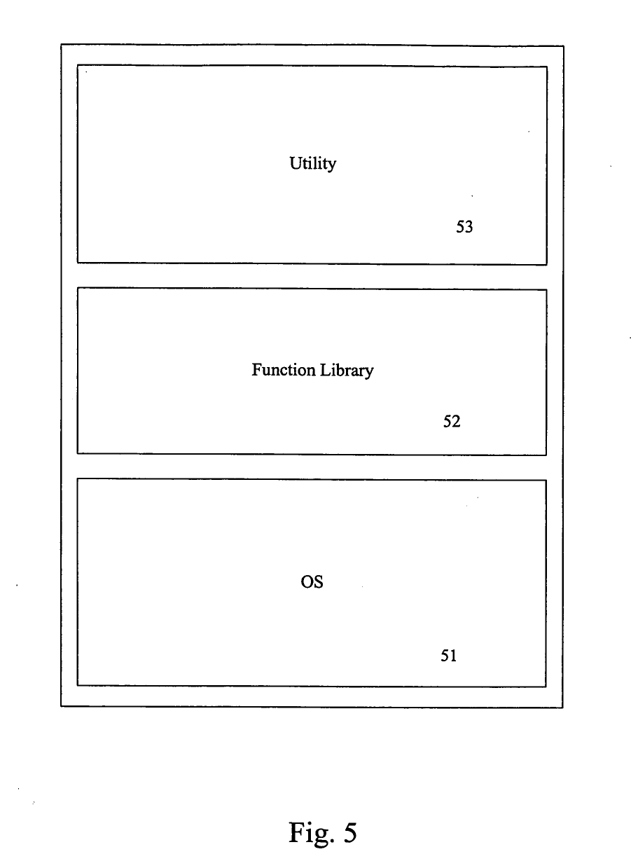

The software system includes a client program and a server program. The client program is installed on several client computers, the server program is installed on the server computer. Since modern computers provide powerful multitasking functions, the server program can also be installed on one or several of the client computers. An embodiment of the system of the client computers and the server computer is shown in FIGS. 4 and 5.

FIG. 4 shows a general-purpose computer hardware structure of the client computers and the server computer. The computer 40 has a processor 401, memory 402, and a secondary storage medium 403, such as a hard drive or an optical drive. The client program and the server program are stored in the hard drive of the computer 40 or an optical disk. The media file, such as a video file, can also be red in the hard drive of the computer 40 or an optical disk. The processor 40 loads the client program and the server program into the memory 402 for execution.

FIG. 5 shows the software structure of the computer 40. The computer 40 is installed with an OS 51, such as the MS Windows system, Linux, Unix, MacOS, BeOS, and OS/2, as the environment for executing the programs. The OS 51 has a dynamic or static link library 52 for the client or server program 53 to use.

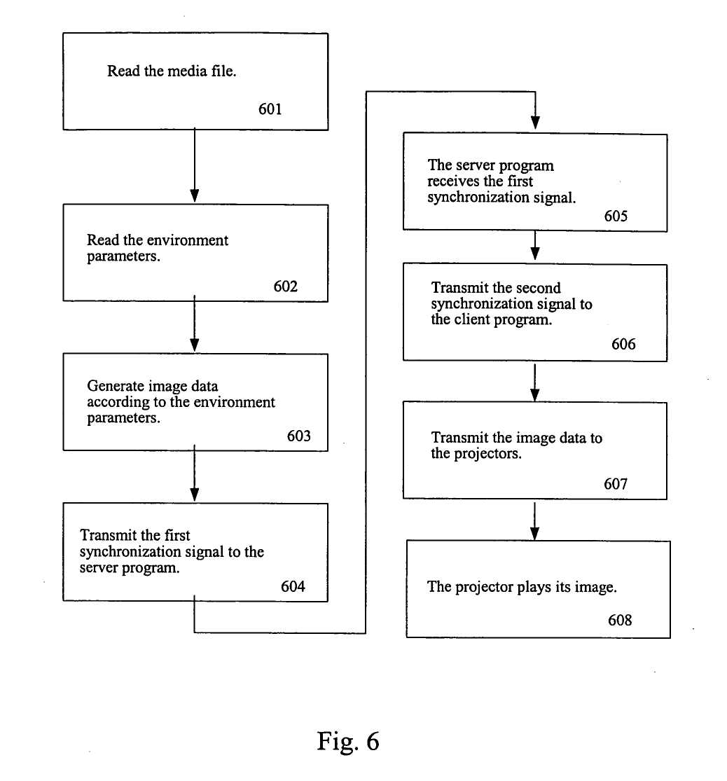

With reference to FIG. 6, the client program executes the following steps. First, it reads a media file, such as a video or image file (step 601) and then an environment parameter (step 602). The environment parameter here can be the coordinates, the curve surface parameters, the boundary-smoothing information, or the 3D visual parameter. Partial images of the media file are generated according to the environment parameter (step 603). Since the image is finished by collaboration, each client program only takes care of one part of the image. After the image is prepared, a first synchronization signal is sent to the network (step 604) using the TCP/IP socket provided by the OS 51 or functions in the function library 52. Afterwards, the client program waits for the second synchronization signal.

The server program receives the first synchronization signal sent by the several client programs (step 605). After the server program receives the first synchronization signal from the client programs, the server program transmits the second synchronization signal to all of the client programs (step 606). After the client programs receive the second synchronization signal, the prepared images are transmitted to the corresponding digital projectors via the OS 51 o the function library 52 (step 607). The projectors finally play the images (step 608).

Simply put, the first synchronization signal means that an individual client program has finished the output image preparation. The second synchronization signal means that all of them have finished the output image preparation. Through the mechanism of the first synchronization signal and the second synchronization signal, the several client programs can simultaneously output the images.

As described before, the environment parameters store the curve surface parameters, the boundary-smoothing information, or the 3D visual parameter. Therefore, a more convenient design is to add an OI program to the server program. The OS program allows the user to dynamically set the environment parameters of each client program. Of course, the OS can also enable the user enter interactive commands for virtual reality. The environment parameters are stored in the client program, independent files, or the registry in the MS Windows OS.

The client program and the server program can be stored in a storage medium for distribution or sale according to the invention. For example, the programs can be stored in the computer recording media such as optical disks, hard drive disks, and floppy disks. Of course, the programs can be executed or downloaded via network connections. All such variations should be considered as within the scope of the invention.

### Fourth Embodiment (Multitasking Device)

The above-mentioned embodiments use general-purpose computers to construct a quick and flexible structure. With the powerful computer functions (e.g. using computers with multiple processors or computer cluster technology), we can design a simple-structure multitasking device to make a multiple-projector playing system.

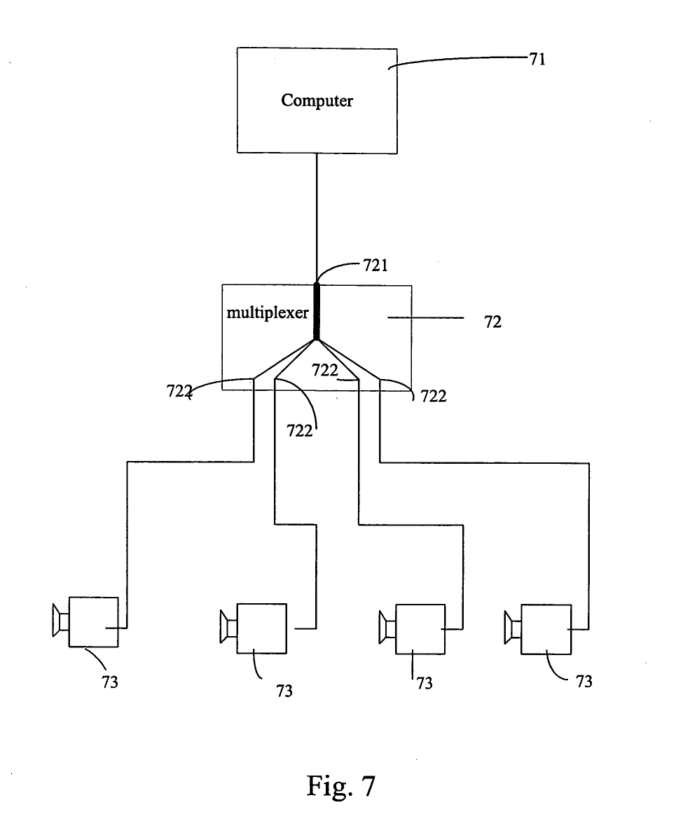

As shown in FIG. 7, the above-mentioned client program, server program, and media file are installed in a computer 71 with powerful calculating abilities. The computer 71 is connected to a multitasking device 72 with one input terminal 721 and several output terminals 722. The computer 71 transmits images for the projectors to the multitasking device 72 via the input terminal 721. The multitasking device 72 distributes the images to the corresponding projectors 73 via different output terminals 722 so that they are projected onto different areas of the screen to form a single image.

The configuration of the projectors can be accomplished according to the description in the above-mentioned embodiments. We do not describe here again.

An Explicit Example

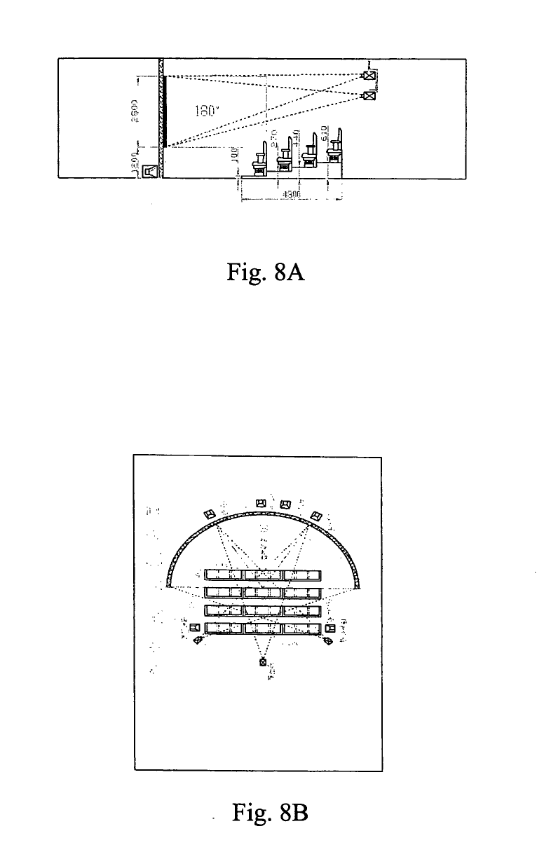

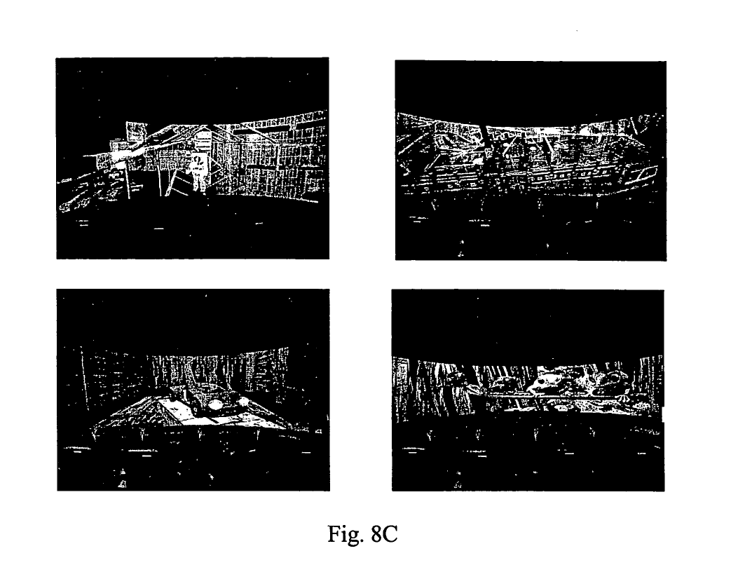

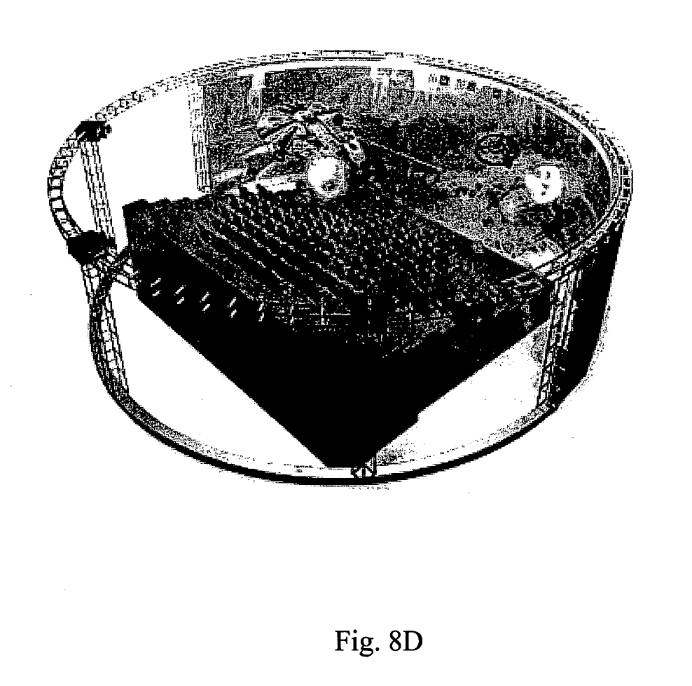

To explicitly emphasize the effects of the invention, we refer to FIGS. 8(a) to 8(d). FIG. 8(a) shows the side view of an example of the projector in a multiple-projector playing system with 3D effects on a 180-degree surrounding screen. Each screen area is assigned with two projectors in order to generate a 3D image, as described above. FIG. 8(b) is a top view of this example. This multiple-projector system can be further equipped with enhanced stereo sound, vibrations, and motion chairs effects. FIG. 8(c) shows several different applications. FIG. 8(d) is a three-dimensional view of the virtual reality system.

With the above description, a person skilled in the art can make a multiple-projector playing system. Such a system has at least the following advantages. First, the system has a large flexibility and scalability. The numbers of client computers and projectors can be increased according to the sizes of screen and media file. Secondly, the disclosed system can be comprised of cheap standardized computers and projectors. Thirdly, the disclosed multiple-projector playing system does not require any specially designed projectors or complicated optical adjustment circuits to dynamically adjust the output results. This solves the adjustment problem when the screen and the processing circuit are separate. Fourth, the invention can be the base of a virtual reality system, using various virtual reality techniques to enhance the value of the whole system.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A projecting system comprising:
a screen, which contains a plurality of areas;
a plurality of projectors, each of which corresponds to one of the screen areas and has an input terminal and a projecting lens, the projecting lens projecting an optical image of a signal entering the input terminal to the corresponding area on the screen;
a network;
a plurality of client electronic devices, each of which has one terminal connected to the input terminal of one of the projectors associated with the electronic device and other terminal connected to the network, and contains a first storage medium for storing a media file, a first program and an environment parameter and a first processor for executing the first program; and
a server electronic device, which is connected to the network and contains a second storage medium for storing a second program and a second processor for executing the second program;
wherein the environment parameter in each of the client electronic devices contains coordinate information, the commands in the first program in each of the client electronic devices include reading the media file, an image signal is computed according to the media file and the coordinate information, a first synchronization signal is transmitted to the server electronic device, the image signal is transmitted to the corresponding projector according to a second synchronization signal, the first synchronization signal is transmitted to the server electronic device, the commands in the second program of the server electronic device include receiving the first synchronization signal from each of the client electronic devices, and the second synchronization signal is transmitted to each of the client electronic devices after the first synchronization signal from all of the client electronic devices are received.

2. The system of claim 1, wherein the environment parameter further includes a curve surface parameter so that the first program also refers to the curve surface parameter to generate the image signal in addition to the media file and the coordinate information.

3. The system of claim 2, wherein the consecutive two areas of the plurality of screen areas have an overlapping region and the environment parameter further includes boundary-smoothing information so that the first program also refers to the boundary-smoothing information to generate the image signal in addition to the media file, the coordinate information and the curve surface parameter, the boundary-smoothing information being used to process the image data in the overlapping region.

4. The system of claim 3, wherein the server electronic device further includes an operating interface (OI) for the user to operate the projecting system.

5. The system of claim 4, wherein the user uses the OI to adjust and set the environment parameters of the client electronic devices.

6. The system of claim 1, wherein the client electronic devices and the server electronic device are general-purpose computers and the first program and the second program are executed on a general-purpose operating system (OS) installed on the general-purpose computers.

7. The system of claim 6, wherein the OS is the Microsoft Windows OS and the environment parameter is stored in the registry of the Microsoft Windows OS.

8. The system of claim 1, wherein the screen is a surrounding screen.

9. The system of claim 1, wherein the network is selected from a TCP/IP network and an IPX network.

10. The system of claim 1, wherein each of the screen areas is designated with two of the projectors and two of the client electronic devices, the environment parameter of each of the two client electronic devices contains a 3D visual parameter, the two client electronic devices generate two image signals for the left and right eyes, respectively, using the difference between the two 3D visual parameters of the two client electronic devices, and the two image signals are projected by the two corresponding projectors to the screen for the user to see a 3D image by wearing a pair of 3D glasses.

11. The system of claim 10, wherein the media file contains 3D space information and the server electronic device contains an OI, the user using the OI and the 3D glasses to experience the virtual reality presented by the 3D space data.

12. A playing system for multiple projectors, the playing system comprising:
a plurality of client computers, each of which is connected to one of the projectors and each of the client computers generates an image signal according to the projecting area of an associated projector and outputs the image signal to the associated projector; and
a network, which connects to the client computers so that the client computers cooperate to drive the projectors for projecting a common image.

13. The system of claim 12, wherein each of the client computers stores a different environment parameter and a same media file so that each of the client computers determines the content in the media file output by the associated projector according to the different environment parameter, thereby generating the image signal.

14. The system of claim 13, wherein the environment parameter includes a curve surface parameter so that the image projected by the projector onto a surrounding screen according to the image signal generated by referring to the curve surface parameter is not distorted.

15. The system of claim 14, wherein the environment parameter includes boundary-smoothing information so that the image signals of adjacent areas with an overlapping region generated in accord with the boundary-smoothing information do not have a fuzzy overlapping region after being projected onto a screen.

16. The system of claim 15 father comprising a server system, which interchange information with the client computers via the network in order to adjust the environment parameters of the client computers for them to cooperate.

17. The system of claim 16, wherein the server system collects synchronization signals sent out by the client computers and controls the client computers to simultaneously finish image projection.

18. The system of claim 16, wherein the server system further includes an OI for the user to adjust the environment parameters of the client computers.

19. The system of claim 12, wherein each of the screen areas is designated with two of the projectors and two of the client computers, the environment parameter of each of the two client computers contains a 3D visual parameter, the two client computers generate two image signals for the left and right eyes, respectively, using the difference between the two 3D visual parameters of the two client computers, and the two image signals are projected by the two corresponding projectors to the screen for the user to see a 3D image by wearing a pair of 3D glasses.

20. The system of claim 19, wherein the media file contains 3D space information and the server electronic device contains an OI, the user using the OI and the 3D glasses to experience the virtual reality presented by the 3D space data.

21. A system using multiple general-purpose projectors to provide a command image, the system comprising:
a multitasking device, which has an input terminal and a plurality of output terminals, each of which corresponds to one of the projectors; and
a processing system, which divides a media file into a plurality of coordinate regions, each of which is associated with at least one of the projectors, computes presentation contents of the media file according to the coordinate region to form a data flow, the data flow is transmitted to the input terminal of the multitasking device, and the multitasking device distributes the data flow to the corresponding output terminals, driving the projectors to show a common image.

22. The system of claim 21, wherein the projectors project images to a surrounding screen and the processing system adjusts the data flow according to a curve surface parameter stored in an environment parameter so that data in a media file are processed in a way that no distortion is seen when the image is projected on the surrounding screen.

23. A playing program comprising:
a client program, which is installed on a plurality of client computers, each of which is associated with a projector and executes the steps of,
reading a media file;
reading an environment parameter,
generating an image signal of one part of the media file according to the environment parameter;
sending a first synchronization signal to a network when the image signal is ready; and
transmitting the image signal to the associated projector after receiving a second synchronization signal; and
a server program, which is installed on a server computer for sending the second synchronization signal to all of the client programs after collecting the first synchronization signals sent from all of the client computers.

24. The playing program of claim 23, wherein the environment parameter includes a curve surface parameter so that the image signal generated by the client program performs a curve surface operation according to the curve surface parameter so that the image projected by the projector onto a non-planar screen is not distorted.

25. The playing program of claim 24, wherein the environment parameter includes boundary-smoothing information so that the image signals of adjacent areas with an overlapping region generated by the client program in accord with the boundary-smoothing information do not have a fuzzy overlapping region after being projected onto a screen.

26. The playing program of claim 29, wherein the server program further provides an OI for the user to adjust the environment parameters of the client computers.

27. A computer readable medium for storing a playing program as in claims 17 to 31.

28. A method of using a plurality of general-purpose projectors to project an image, the method comprising the steps of:
storing a media file in a plurality of client computers, each of which being associated with one of the projectors and the media file storing contents of the image;
dividing the image into a plurality of areas, each of which is projected by at least one of the projectors;
setting an environment parameter for each of the client computers, the environment parameter containing coordinates of the area covered by the projector associated with the client computer;
each of the client computer's reading the media file, generating an image signal according to the environment parameter, and sending the image signal to the associated projector; and
generating a plurality of optical images according to the image signals by the projectors so that the optical images form the image; wherein the environment parameters of the client computers have the effect that the image projected by the projectors does not distort because of the distance between the screen and the projectors and the shape of the screen.

29. The method of claim 28 further comprising the step of providing a network connecting to the client computers.

30. The method of claim 29 further comprising the step of providing a server computer connected to the network for synchronizing the client computers.

31. The method of claim 30, wherein the environment parameter includes a curve surface parameter so that the image projected by the projector onto a surrounding screen according to the image signal generated by referring to the curve surface parameter is not distorted.

32. The method of claim 28, wherein the environment parameter includes boundary-smoothing information so that the image signals of adjacent areas with an overlapping region generated in accord with the boundary-smoothing information do not have a fuzzy overlapping region after being projected onto a screen.

33. The method of claim 28, wherein each of the areas is designated with two of the projectors and two of the client electronic devices, the environment parameter of each of the two client computers contains a 3D visual parameter, the two client computers generate two image signals for the left and right eyes, respectively, using the difference between the two 3D visual parameters of the two client computers, and the two image signals are projected by the two corresponding projectors to the screen for the user to see a 3D image by wearing a pair of 3D glasses.

34. A 3D virtual reality system comprising:
a network;
a plurality of general-purpose projectors;
a plurality of client computers connected to the network, wherein each of the client computers is connected to one of the projectors, each of the client computers stores a media file and a environment parameter, the media file defines a 3D model, and the environment parameter contains coordinate information to determine an image signal generated by the client computer according to the 3D model and sent to the associated projector and a 3D visual parameter so that for each coordinate region two image signals are generated by two of the client computers and adjusted according to their 3D visual parameters in such a way that the user sees a 3D image by wearing a pair of 3D glasses; and
a server computer, which is connected to the network and has an OI for the user to enter an action command, following which the OI adjust the environment parameters of the client computers in order to perform a virtual reality operation on the 3D space model accordingly.

35. The system of claim 34, wherein the user uses the OI to dynamically adjust the environment parameters of the client computers for the system to be adapted to screens of different shapes and distances.

36. The system of claim 35, wherein the environment parameter includes a curve surface parameter so that the image signal generated according to the curve surface parameter is not distorted after being projected onto a surrounding screen.

37. The system of claim 35, wherein the environment parameter includes boundary-smoothing information so that the image signals of adjacent areas with an overlapping region generated in accord with the boundary-smoothing information do not have a fuzzy overlapping region after being projected onto a screen.
